(19) United States
(12) Patent Application Publication
(10) Pub. No.: US 2014/0286853 A1
(43) Pub. Date: Sep. 25, 2014

(54) Processes and Systems for Recovering Bromine Using Bromide Liquids

(71) Applicant: MARATHON GTF TECHNOLOGY, LTD., Houston, TX (US)

(72) Inventor: John J. Waycuilis, Cypress, TX (US)

(73) Assignee: MARATHON GTF TECHNOLOGY, LTD., Houston, TX (US)

(21) Appl. No.: 14/216,478

(22) Filed: Mar. 17, 2014

Related U.S. Application Data
(60) Provisional application No. 61/803,978, filed on Mar. 21, 2013.

(51) Int. Cl. C01B 7/09

(52) U.S. Cl. CPC C01B 7/096
USPC 423/503; 422/288

(57) ABSTRACT

Processes and systems for recovering bromine. A process may comprise contacting a gas stream comprising bromine with a liquid bromide stream comprising bromide anions to produce at least an off-gas stream that is substantially bromine free and a liquid stream comprising bromine anionic complexes; and heating at least a portion of the liquid stream to produce at least bromine from at least a portion of the bromine anionic complexes.

### BACKGROUND OF THE INVENTION

The present invention relates generally to processes and systems for recovering bromine and, in one or more embodiments, to processes and systems for recovering bromine that comprise absorption of bromine from a gas stream into a liquid stream comprising a bromide salt and subsequently heating the liquid causing desorption of the bromine and regeneration of the liquid stream for re-use.

Very efficient recovery of dilute elemental bromine contained in a gas stream is often a problem encountered in the production of bromine from natural sources or in other processes that use bromine as a synthetic agent. In some instances, hydrogen bromide or other bromide may be produced as a byproduct in these processes. In such processes, if the bromide is oxidized with air back to bromine for recycling within the process, even after bulk recovery of the bromine by condensation, for example, some trace bromine may remain in the oxygen-depleted gas stream leaving the oxidation process. One example of such a process where bromine is used as a synthetic agent and byproduct hydrogen bromide is oxidized to regenerate the bromine is a bromine-based process for the conversion of gaseous alkanes to liquid hydrocarbons.

A typical process for the recovery of bromine from gas streams includes absorption of bromine into a water stream. However, the solubility of elemental bromine in pure water is limited to about 3 weight percent (wt %) at ambient temperatures so a fairly large amount of water typically must be circulated to recover a given amount of bromine. Further, because the solubility is relatively low it can be difficult to attain nearly complete recovery of bromine from the residual gas stream. Strong caustic solutions, such as sodium hydroxide, may also be used in bromine recovery from gas streams, in which the elemental bromine hydrolyzes in water and then reacts with the caustic to form a bromide salt, such as sodium bromide. However, once converted to a bromide salt, it is not readily converted back to elemental bromine, typically requiring chemical or electrolytic oxidation. Solid beds of activated carbon or zeolite have also been used to recover bromine from gas streams, but the capacity of the beds for bromine are not high, requiring large beds of the solid absorbent. In addition, multiple beds may be required for a continuous process, and the beds must cyclically switched and thermally regenerated, which adds to the complexity and cost.

Thus, since bromine is a valuable chemical and emissions of elemental bromine to the environment should be reduced to as low a level as possible, a need exists for a highly efficient process for recovering bromine and minimizing emissions.

### BRIEF SUMMARY OF THE INVENTION

To achieve the foregoing and other objects, and in accordance with the purposes of the present invention, as embodied and broadly described herein, one embodiment of the present invention is a process that may comprise contacting a gas stream comprising bromine with a liquid bromide stream comprising bromide anions to produce at least an off-gas stream that is substantially bromine free and a liquid stream comprising bromine anionic complexes; and heating at least a portion of the liquid stream to produce at least bromine from at least a portion of the bromine anionic complexes.

Another embodiment of the present invention is a process that may comprise contacting a gas stream comprising bromine with a liquid bromide stream comprising hydrogen bromide dissolved in water in an absorption stage to remove bromine from the gas stream and produce at least a liquid stream comprising bromine anionic complexes, wherein the bromine is removed such that the gas stream comprises bromine in an amount about 10 parts per million by weight or less. The method further may comprise contacting the gas stream with a water stream in the absorption stage to remove bromides from the gas stream such that the gas stream comprises hydrogen bromide in an amount of about 10 parts per million by weight or less, wherein the bromides in the gas stream were vaporized from the liquid bromide stream. The method further may comprise heating at least a portion of the liquid stream to convert at least a portion of the bromine anionic complexes to bromine and hydrogen bromide.

Yet another embodiment of the present invention is a system that may comprise an absorber column having an inlet for a liquid bromide stream and an inlet for a gas stream comprising bromine, the absorber column being configured to countercurrently contact the liquid bromide stream with the gas stream so as to dissolve at least a portion of the bromine in the liquid bromine stream and produce at least an off-gas stream that is substantially bromine free and a liquid stream comprising bromine anionic complexes. The system further may comprise a stripper column having an inlet for the liquid stream, the stripper column being configured to heat the liquid stream releasing bromine from the liquid stream.

### BRIEF DESCRIPTION OF THE SEVERAL VIEWS OF THE DRAWINGS

FIG. 1 is a block flow diagram of one embodiment of the processes and systems of the present invention.

FIG. 2 is a block flow diagram of another embodiment of the processes and systems of the present invention.

FIG. 3 is a block flow diagram of yet another embodiment of the processes and systems of the present invention.

FIG. 4 is a block flow diagram of still another embodiment of the processes and systems of the present invention.

FIG. 5 is an illustration of an example experimental apparatus.

### DETAILED DESCRIPTION OF THE INVENTION

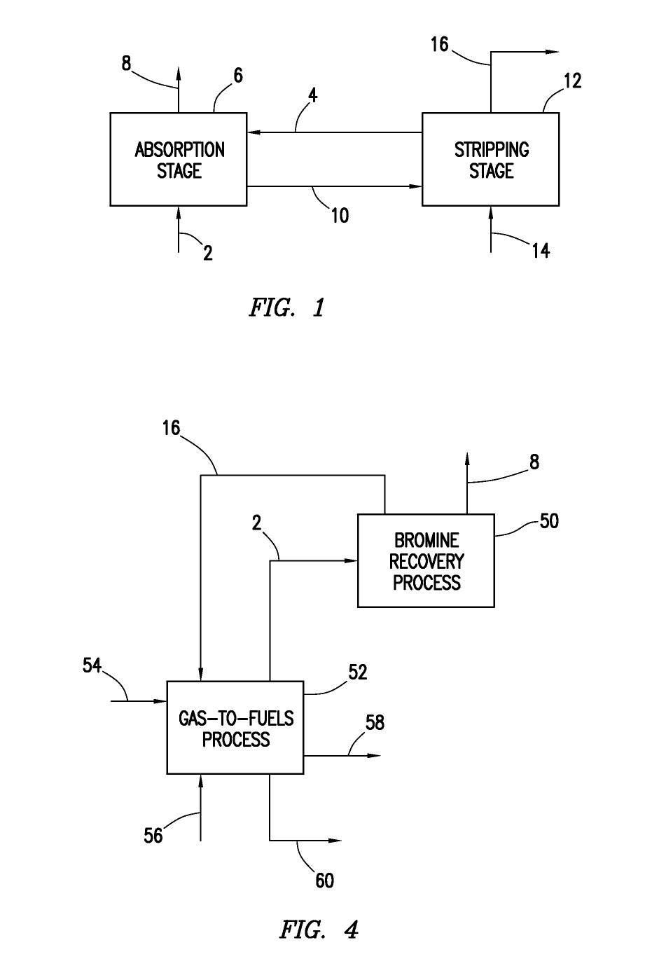

A schematic generally depicting embodiments of the processes and systems of the present invention is illustrated in FIG. 1. In accordance with the schematic as illustrated in FIG. 1, a gas stream 2 comprising elemental bromine may be contacted by a bromide-containing liquid stream 4 in an absorption stage 6. In the absorption stage 6, the bromine may form bromine anionic complexes (e.g., Br₃⁻, Br₅⁻) with the bromide anions in the bromide-containing liquid stream 4. Advantageously, a significantly higher concentration of bromine can be dissolved in the bromide-containing liquid stream 4 comprising bromide anions than in water. An off-gas stream 8 may be withdrawn from the absorption stage 6 that is substantially bromine free. A bromine-rich bromide stream 10 may also be withdrawn from the absorption stage 6. Although absorption stage 6 is shown as a single stage, it will be apparent to the skilled practitioner that in certain instances it may be advantageous to utilize a multi-stage absorption in which the gas stream 2 comprising bromine flows countercurrently to bromide-containing liquid stream 4, in order to minimize the rate of the bromide-containing liquid stream 4 required to recover substantially all the bromine.

Suitable sources that may generate the gas stream 2 in various embodiments of the present invention include the production of bromine or oxidation of hydrogen bromide or other bromide. Preferably, the gas stream 2 is at a temperature below 50° C. and more preferably below about 30° C. For example, the gas stream 2 shown in FIG. 1 may be all or a portion of a stream generated in the production of bromine from bromide-rich brines via chlorination with removal of the bromine product via air stripping. By way of further example, the gas stream 2 shown in FIG. 1 may be all or a portion of an oxygen-depleted gas stream from the oxidation of hydrogen bromide or other bromide in a bromine-based process for the conversion of gaseous alkanes to liquid hydrocarbons. In general, the gas stream 2 may be any of a variety of different gas streams comprising bromine that may be generated in any number of processes in which it may be desirable to recover bromine therefrom, for example, to minimize emissions. The bromine recovered in embodiments of the present invention may be a product stream for external sale in some embodiments, a recycle stream for internal reuse in other instances, or a feed stream for downstream process in other examples.

In accordance with present embodiments, the gas stream 2 may comprise a dilute amount of bromine. For example, the gas stream 2 may comprise bromine in an amount of about 5 wt % or less. In some embodiments, the gas stream 2 may comprise bromine in an amount of about 3 wt %, about 2 wt %, or even less. In some embodiments, the gas stream 2 may comprise bromine in an amount in a range of from about 1 wt % to about 2 wt %. The gas stream 2 may further comprise any of a number of different gases, including oxygen and nitrogen, for example. In one particular embodiment, the gas stream 2 may comprise nitrogen in an amount of about 77 wt % to about 98 wt %, oxygen in an amount of about 1 wt % to about 20 wt %, and bromine in an amount of about 1 wt % to about 2 wt %. In another embodiment, the gas stream 2 may comprise nitrogen in an amount of about 90 wt % to about 98 wt %, oxygen in an amount of about 1 wt % to about 10 wt %, and bromine in an amount of about 1 wt % to about 2 wt %. Those of ordinary skill in the art, with the benefit of this disclosure, should appreciate that the gas stream 2 may contain amounts of these components that may be outside these ranges as may be appropriate for a particular application.

In accordance with present embodiments, the bromide-containing liquid stream 4 may be fed to the absorption stage 6 at a temperature of less than about 50° C. and preferably at a pressure of about 1 atmosphere or higher. Operation at higher pressures and lower temperatures should generally increase the efficiency of the process as the solubility of bromine in the bromide-containing liquid 4 generally increases as temperature is reduced and may increase somewhat as pressure is increased. In some embodiments, the bromide-containing liquid stream 4 may be fed at a temperature of less than about 30° C. In some embodiments, the liquid in the bromide-containing liquid stream 4 may comprise water containing bromide anions. It should be understood, however, that other non-aqueous liquids containing bromide anions may also be suitable in alternative embodiments. For example, non-aqueous liquids that may be suitable include ionic liquids having a bromide ion or bromide ionic complex as a counter-ion, solutions of metal bromide salts in non-aqueous solvents such as carbon disulfide, eutectic mixtures of metal bromide salts, etc.

In some embodiments, a bromide-anion source may be dissolved in the bromide-containing liquid stream 4 to form the bromide anions. Any of a variety of different bromide-anion sources may be suitable for use in embodiments of the present invention, including metal bromides, such as alkali-metal bromides, alkaline-earth-metal bromides, transition-metal bromides, and combinations thereof Alkali-metal series bromides that may be suitable include hydrogen bromide, sodium bromide, potassium bromide, and the like. Due to the formation of bromine anionic complexes (e.g., Br₃⁻, Br₄⁻) in solutions containing bromide anions, the solubility of bromine in solutions of alkali-metal bromides may be quite high even at ambient temperatures, for example. However, the bromine anionic complexes should not be so strong as to be irreversible. Accordingly, the bromine anionic complexes may be dissociated at higher temperatures resulting in the liberation of bromine, as will be discussed in more detail below. In addition to alkali-metal bromides, solutions of alkaline-earth-metal bromides, such as magnesium bromide, calcium bromide, and the like, have similar properties and may also be suitable as the bromide-anion source in embodiments of the present invention. Further, transition-metal bromides, such as iron (III) bromide, cobalt (II) bromide, copper (II) bromide, zinc bromide, and the like, may also be used as the bromide-anion source in some embodiments.

While the preceding description describes a number of different bromide anion sources and liquids that may be used, metal bromides that include mono-valent cations, such as potassium bromide, sodium bromide, and zinc bromide, dissolved in water may be utilized in accordance with certain embodiments. Metal bromides that include di-valent cations, such as iron (III) bromide or copper (II) bromide, may be used but are less preferred because these can thermally decompose at higher temperatures to iron (II) bromide and copper (I) bromide, respectively, which have substantially lower solubility in water and, thus, may precipitate. In some embodiments, the bromide may be hydrogen bromide, which has the advantage of a very high solubility for bromine; however, hydrogen bromide has the disadvantage of having a significant vapor pressure and being more corrosive, since it forms a strong acid when dissolved in water. Nevertheless, in some embodiments, hydrogen bromide dissolved in water may be useful, for example, where it is already produced by a process, thus avoiding the need for a secondary salt. In one embodiment, the bromide-containing liquid stream 4 may comprise hydrogen bromide in an amount of about 60 wt % or less. In general, the hydrogen bromide or other bromide-anion source may be included in the bromide-containing liquid stream 4 in an amount as close to the saturation limit as possible without precipitation at process temperatures. It should be understood, however, that the specific amount of the bromide-anion source that can be dissolved in the bromide-containing liquid stream 4 in embodiments varies dependent upon a number of factors, including the process temperatures and the particular bromide-anion source selected, among others.

As previously mentioned, the gas stream 2 comprising bromine may be contacted by the bromide-containing liquid stream 4 in the absorption stage 6. As the gas stream 2 contacts the bromide-containing liquid stream 4, substantially all of the bromine in the gas stream 2 should dissolve into the bromide-containing liquid stream 4 in accordance with present embodiments. For example, the bromine should form bromine anionic complexes (e.g., Br₃⁻, Br₅⁻) with the bromide anions in the bromide-containing liquid stream 4.

The off-gas stream 8 may be withdrawn from the absorption stage 6 in accordance with embodiments of the present invention. As previously mentioned, the off-gas stream 8 may be substantially bromine free, for example containing bromine in an amount of about 10 parts per million by weight (“ppmw”) or less. In some embodiments, the off-gas stream 8 may contain bromine in an amount of about 1.0 ppmw or less.

With continued reference to FIG. 1, the bromine-rich bromide stream 10 may be withdrawn from the absorption stage 6 and fed to the bromine-stripping stage 12 in accordance with present embodiments. As previously described, the bromine-rich bromide stream 10 may comprise bromine anionic complexes (e.g., Br₃⁻, Br₅⁻) that formed in the bromide-containing liquid stream 4 due to dissolution of the bromine therein. The bromine-rich bromide stream 10 may also contain some residual bromide anions that entered the absorption stage. Heat may be supplied to the bromine-stripping stage 12 to recover bromine from the bromine-rich bromide stream 10. For example, the heat can cause disassociation of the bromine complexes resulting in the release of bromine. Optionally, a stripping gas 14 may also be introduced into the bromine-stripping stage 12. The stripping gas 14 may comprise, for example, air, nitrogen, steam, a lower molecular weight alkane (e.g., methane, ethane, etc.), or a combination thereof. In the bromine-stripping stage 12, the stripping gas 14 may contact the bromine-rich bromide stream 10, thus facilitating the recovery of bromine there from. For example, the bromine contained in the bromine-rich bromide stream 10 may be volatized and carried by the stripping gas 14. Although the stripping stage 12 is shown as a single stage, it will be apparent to the skilled practitioner that in certain instances it may be advantageous to utilize a multi-stage stripping in which the stripping gas 14 flows counter-currently to bromine-rich bromide stream 10, in order to maximize the removal of bromine there from.

The bromide-containing liquid stream 4 may be withdrawn from the stripping stage 12 and recycled to the absorption stage 6. A bromine gas stream 16 may also be withdrawn from the stripping stage 12. The bromine gas stream 16 may comprise bromine as well as water vapor and/or non-condensable gases from the stripping gas 14. It is preferred that the process described with respect to FIG. 1 operate continuously.

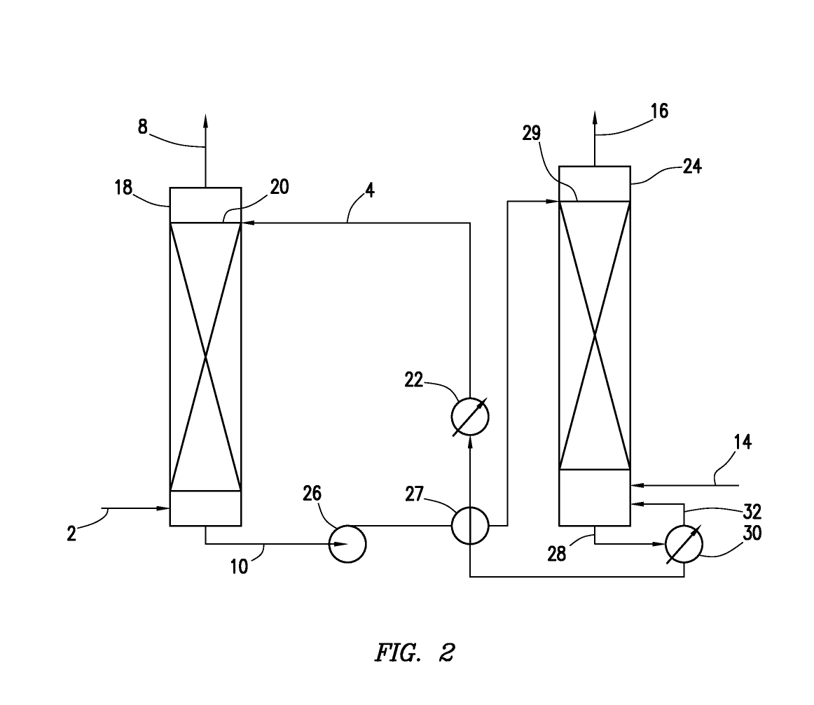

Referring now to FIG. 2, another embodiment of the processes and systems of the present invention is illustrated. A gas stream 2 comprising bromine may be introduced into an absorber column 18. In the illustrated embodiment, the gas stream 2 is introduced at or near the bottom of the absorber column 18. A bromide-containing liquid stream 4 may also be introduced into the absorber column 18. Prior to introduction into the absorber column 18, the bromide-containing liquid stream 4 may be cooled to a temperature of less than about 50° C. in a heat exchanger 22. In some embodiments, the bromide-containing liquid stream 4 may be cooled in the heat exchanger 22 to a temperature of less than about 30° C. In the illustrated embodiment, the bromide-containing liquid stream 4 is introduced at or near the top of the absorber column 18.

The absorber column 18 may contain a number of trays or equivalent packing material, identified as 20 in FIG. 2, as should be evident to one of ordinary skill in the art. The gas stream 2 may be introduced into the absorber column 18 at or below the bottom of the packing material 20. The bromide-containing liquid stream 4 may be introduced into the absorber column 18 at or above the top of the packing material 20. One of ordinary skill in the art should readily be able to determine the number of trays or volume of the packing material 20 to use for a particular application. While FIG. 2 illustrates only one section of packing material 20, embodiments may include more than one section of packing material 20 as will be evident to those of ordinary skill in the art. In the illustrated embodiment, the absorber column 18 operates countercurrently with the bromide-containing liquid stream 4 being distributed down the packing material 20 and contacting the upwardly flowing gas stream 2. As the gas stream 2 contacts the bromide-containing liquid stream 4, substantially all of the bromine in the gas stream 2 should dissolve into the bromide-containing liquid stream 4 in accordance with present embodiments. By reaction with the bromide anions in the bromide-containing liquid stream 4, the bromine should form bromine anionic complexes (e.g., Br₃⁻, Br₅⁻). An off-gas stream 8 that may be substantially bromine free may be withdrawn from at or near the top of the absorber column 18, for example. A bromine-rich bromide stream 10 may be withdrawn from at or near the bottom of the absorber column 18, for example. The bromine-rich bromide stream 10 may comprise bromine anionic complexes (e.g., Br₃⁻, Br₅⁻) that formed in the bromide-containing liquid stream 4 due to dissolution of the bromine therein.

As illustrated, the bromine-rich bromide stream 10 may be conveyed to stripper column 24 via pump 26. Prior to introduction into the stripper column 24, the bromine-rich bromide stream 10 may be heated in a heat exchanger 27, for example, by cross exchange with the bromide-containing liquid stream 4, as shown in FIG. 2. The bromine-rich bromide stream 10 may be heated in the heat exchanger 27 to a temperature of at least about 60° C. in one embodiment and at least about 80° C. in another embodiment.

In the illustrated embodiment, the bromine-rich bromide stream 10 may be introduced at or near the top of the stripper column 24. The stripper column 24 may contain a number of trays or equivalent packing material identified as 29 in FIG. 2, as will be evident to those of ordinary skill in the art. The bromine-rich bromide stream 10 may be introduced into the stripper column 24 at or above the top of the packing material 29. One of ordinary skill in the art should readily be able to determine the number of trays or volume of the packing material 29 to use for a particular application. While FIG. 2 illustrates only one section of packing material 29, embodiments may include more than one section of packing material 29 as will be evident to those of ordinary skill in the art. A bottoms liquid stream 28 may be withdrawn from the bottom of the stripper column 24 and heated in a heat exchanger 30. The bottoms stream 28 may be heated in the heat exchanger 30 to a temperature of at least about 70° C., producing a liquid stream (e.g., bromide-containing liquid stream 4) and a gas stream 32. In some embodiments, the bottoms liquid stream 28 may be heated to a temperature of at least about 90° C. The liquid stream may be recycled to the absorber column 18 as bromide-containing liquid stream 4. Regarding the gas stream 28 generated in the heat exchanger 30, the heat supplied to the bottoms liquid stream 28 should cause disassociation of the bromine complexes resulting in the release of bromine gas. The bromine gas can be returned to the stripper column 24 via gas stream 32. Gas stream 32 may also comprise water or other components of the bromine-rich bromide stream 10 that may be vaporized in the heat exchanger 30. The gas stream 32 should flow upwardly through the packing material 29 contacting the downwardly flowing bromine-rich bromide stream 10, thus facilitating the recovery of bromine there from. For example, the bromine contained in the bromine-rich bromide stream 10 may be volatized and carried to the top of the stripping column 24 exiting as stream 16 leaving the top of the stripper column 24. Optionally, a stripping gas 14 may also be introduced into the stripper column 24. The stripping gas 14 may flow upward through the packing material 29 contacting the downwardly flowing bromine-rich bromide stream 10. A bromine gas stream 16 may be recovered as the overhead gas stream of the stripper column 24. It is preferred that the process described with respect to FIG. 2 operate continuously.

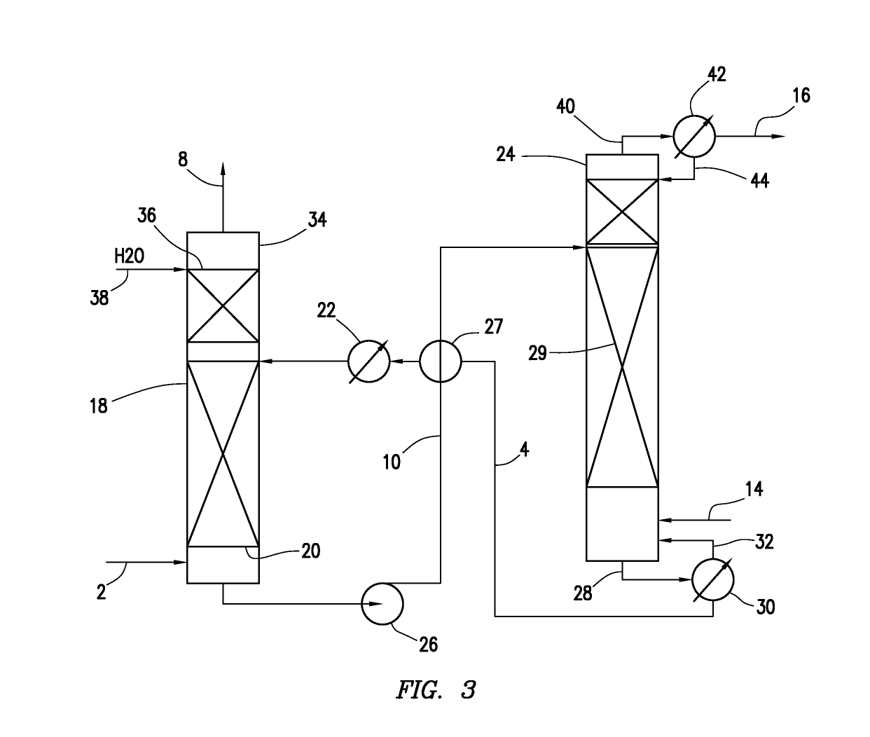

Referring now to FIG. 3, an alternative embodiment of the processes and systems of the present invention is illustrated. As illustrated, a water-wash section 34 is shown above the top stage of the absorber column 18. Those of ordinary skill in the art will appreciate that the water-wash section 34 may be in the same or a different vessel from the absorber column 18. The water-wash section 34 may contain a number of trays or equivalent packing material identified as 36 in FIG. 3, as will be evident to those of ordinary skill in the art. One of ordinary skill in the art should readily be able to determine the number of trays or volume of the packing material 36 to use for a particular application. While FIG. 3 illustrates only one section of packing material 36, embodiments may include more than one section of packing material 36 as will be evident to those of ordinary skill in the art. A water stream 38 may be introduced into the water-wash section 34. In the illustrated embodiment, the water stream 38 may be introduced into the water-wash section 34 at or above the top of the packing material 36. As illustrated, the water-wash section 34 may operate countercurrently with the water stream 38 being distributed down the packing material 36 and contacting the upwardly flowing gas stream 2. As the water stream 38 contacts the gas stream 2, at least a portion of the volatile bromide, such as hydrogen bromide in the case of an aqueous solution of hydrobromic acid, that may have vaporized in absorber column 18 and be carried by the gas stream 2 may be removed from the gas stream 2. Accordingly, the off-gas stream 8 withdrawn from the water-wash section 34 may be substantially free of volatile bromides, for example, containing hydrogen bromide in an amount of about 10 ppmw or less. In some embodiments, the off-gas stream 8 may contain about 1.0 ppmw volatile bromides or less. A water-wash section 34 may be particular suitable where a volatile bromide, such as hydrogen bromide, is used that is corrosive and has a significant vapor pressure even at the relatively low absorber temperature of less than about 50° C., for example.

With continued reference to FIG. 3, an overhead gas stream 40 from the stripper column 24 may be introduced to heat exchanger 42 and partially condensed to form a gas stream (e.g., bromine gas stream 16) and a liquid stream 44. In accordance with present embodiments, the heat exchanger 42 can cool the overhead gas stream 40 to below the dew point of water at the operating pressure of the stripper column 24, but not below the dew point of bromine. The gas stream from the heat exchanger 42 may be recovered as bromine gas stream 16. The bromine gas stream 16 may comprise bromine as well as water vapor and/or non-condensable gases from the stripping gas 14. The temperature of the bromine gas stream 16 should be controlled so that sufficient water vapor leaves in the bromine gas stream 16 to avoid an increase in dilution of the bromide-containing liquid stream 4 due to addition of the water stream 38 in the water-wash section 34. For example, the bromine gas stream 16 may be at a temperature of about 60° C. to about 90° C. and at a pressure of about 1 atm. While FIG. 3 illustrates that the heat exchanger 42 for condensing overhead gas stream 40 of the stripper column 24 is used in conjunction with water-wash section 34 of the absorber column 18, it should be understood that the heat exchanger 42 may be used on the stripper column 24 in embodiments without a water-wash section 34 on the absorber column 18 and vice versa.

In accordance with embodiments of the present invention, the processes described above with respect to FIGS. 1-3 for recovery of bromine from a gas stream may be used in a gas-to-fuels process that utilizes bromine in the conversion of gaseous alkanes to liquid hydrocarbons. For example, dilute bromine contained in a gas stream and produced in the oxidation of hydrogen bromide produced in the bromine-based process may be recovered as previously described.

The term “higher molecular weight hydrocarbons” as used herein refers to hydrocarbons comprising a greater number of carbon atoms than one or more components of the feedstock. For example, natural gas is typically a mixture of light hydrocarbons, predominately methane, with lesser amounts of ethane, propane, and butane, and even smaller amounts of longer chain hydrocarbons such as pentane, hexane, etc. When natural gas is used as a feedstock, higher molecular weight hydrocarbons produced in accordance with embodiments of the present invention may include a hydrocarbon comprising C2 and longer hydrocarbon chains, such as propane, butane, C5+ hydrocarbons, aromatic hydrocarbons, and mixtures thereof In some embodiments, part or all of the higher molecular weight hydrocarbons may be used directly as a product (e.g., LPG, motor fuel, etc.). In other instances, part or all of the higher molecular weight hydrocarbons may be used as an intermediate product or as a feedstock for further processing. In yet other instances, part or all of the higher molecular weight hydrocarbons may be further processed, for example, to produce gasoline grade fuels, diesel grade fuels, and fuel additives. In some embodiments, part or all of the higher molecular weight hydrocarbons obtained by the processes of the present invention can be used directly as a motor gasoline fuel having a substantial aromatic content, as a fuel blending stock, or as feedstock for further processing such as an aromatic feed to a process producing aromatic polymers such as polystyrene or related polymers.

The end use of the higher molecular weight hydrocarbons may depend on the particular catalyst employed in the oligomerization portion of the methods discussed below, as well as the operating parameters employed in the process. Other uses should be evident to those skilled in the art with the benefit of this disclosure.

Lower molecular weight alkanes may be used as a feedstock in the processes described herein for the production of higher molecular weight hydrocarbons. A suitable source of lower molecular weight alkanes may be natural gas. As used herein, the term “lower molecular weight alkanes” refers to methane, ethane, propane, butane, pentane or mixtures of two or more of these individual alkanes. The lower molecular weight alkanes may be from any suitable source, for example, any source of gas that provides lower molecular weight alkanes, whether naturally occurring or synthetically produced. Examples of sources of lower molecular weight alkanes for use in the processes of the present invention include, but are not limited to, natural gas, coal-bed methane, regasified liquefied natural gas, gas derived from gas hydrates and/or clathrates, gas derived from anaerobic decomposition of organic matter or biomass, gas derived in the processing of tar sands, and synthetically produced natural gas or alkanes. Combinations of these may be suitable as well in some embodiments. In some embodiments, it may be desirable to treat the feed gas to remove undesirable compounds, such as sulfur compounds and carbon dioxide. In any event, it is important to note that small amounts of carbon dioxide, e.g., less than about 2 mol %, can be tolerated in the feed gas to the processes of the present invention.

FIG. 4 is a schematic diagram illustrating an embodiment of the processes and systems of the present invention that includes a bromine-recovery process 50, as described above, in conjunction with a gas-to-fuels process 52 that utilizes bromine. In the illustrated embodiment, the gas-to-fuels process 52 converts gaseous alkanes to liquid hydrocarbons via a bromine-based process. One feed to the gas-to-fuels process 52 may include a feed gas stream 54, which may comprise lower molecular weight alkanes, such as natural gas, for example. Another feed to the gas-to-fuels process may include an oxidant stream 56, which may comprise oxygen, for example. Yet another feed to the gas-to-fuels process 52 may include bromine gas stream 16 from the bromine-recovery process 50. As illustrated, at least one liquid product stream 58 may be withdrawn from the gas-to-fuels process 52. The liquid product stream 58 may comprise at least a portion of the higher molecular weight hydrocarbons generated in the process 52. In some embodiments, the liquid product stream 58 may comprise heavy-end hydrocarbons (C5+). In other embodiments, the liquid product stream 58 may further comprise light-end hydrocarbons (C2-C4) in the same or a different stream as the heavy-end hydrocarbons. A water stream 60 may also be withdrawn from the gas-to-fuels process 52, for example, from oxidation of the hydrogen bromide byproduct from the gas-to-fuels process 52, as described below.

In general, embodiments of the gas-to-fuels process 52 may include reaction of gaseous alkanes, which may be lower molecular weight alkanes, with bromine to produce alkyl bromides and hydrogen bromide. The gaseous alkanes may include at least a portion of the feed gas stream 54 as well recycled alkanes. The resultant alkyl bromides may be reacted over a suitable catalyst under sufficient conditions to produce hydrogen bromide and higher molecular weight hydrocarbons, including light end hydrocarbons (C2-C4) and heavy end hydrocarbons (C5+), as well as some methane (C1). Those of ordinary skill in the art should appreciate, with the benefit of this disclosure, that the particular higher molecular weight hydrocarbons produced will be dependent, for example, upon the catalyst employed, the composition of the alkyl bromides, and the exact operating parameters employed in the alkyl bromide conversion. Catalysts that may be employed include synthetic crystalline alumino-silicate catalyst, such as a zeolite catalyst, as should be recognized by those of ordinary skill in the art with the benefit of this disclosure. Embodiments of the gas-to-fuels process 52 further may include recovery of the hydrogen bromide produced in the bromination and alkyl bromide conversion by one of several processes, e.g., fractionation, absorbing hydrogen bromide and neutralizing the resulting hydrobromic acid with an aqueous solution of partially oxidized metal bromide salts (as metal oxides/oxy-bromides/bromides) to produce metal bromide salt and water in an aqueous solution; reacting HBr with metal oxide, absorbing hydrogen bromide into water or an aqueous hydrobromic acid solution using a packed tower or other contacting device. Embodiments further may include oxidation of the recovered hydrogen bromide or other bromide with the oxidant stream 56 to generate bromine, which can be recycled to the bromination. In this oxidation, an oxygen-depleted gas stream may be produced that comprises some bromine.

With continued reference to FIG. 4, all or a portion of the oxygen-depleted gas stream from the oxidation may be withdrawn from the gas-to-fuels process 52 as gas stream 2 and conveyed to the bromine-recovery process 50, which comprises at least one absorption stage 6 and at least one stripping stage 12, as discussed above with respect to FIG. 1, for example. The equipment illustrates on FIGS. 2 and 3 may also be utilized with the bromine-recovery process 50 shown on FIG. 4. In the bromine-recovery process 50, the bromine may be separated from the gas stream 2 to yield on off-gas stream 8 that is substantially free of bromine. A bromine stream 16 comprising the separated bromine may be withdrawn from the bromine-recovery process 50 and recycled back to the gas-to-fuels process 52.

To facilitate a better understanding of the present invention, the following examples of certain aspects of some embodiments are given. The following examples should not be read or construed in any manner to limit, or define, the entire scope of the invention.

### EXAMPLES

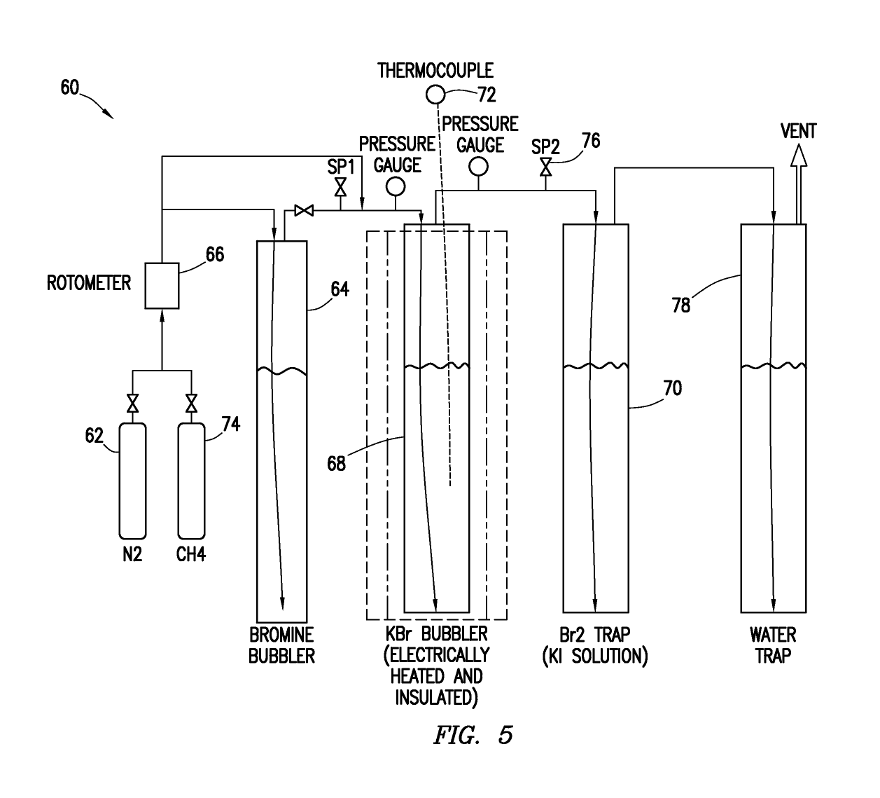

FIG. 5 illustrates a laboratory experimental apparatus 60 that was used to conduct the examples that follow. In particular, the experimental apparatus 60 was used to test absorption of bromine into a metal bromide liquid and also to test desorption of the bromine from the metal bromide liquid in accordance with the procedures that follow.

In a first absorption experimental step, nitrogen from N₂ tank 62 is introduced into a Br₂ bubbler 64 at a rate of 15 mL/min as determined by rotometer 66. The nitrogen becomes saturated with bromine vapor in the Br₂ bubbler 64 which is at ambient temperature. A gas stream containing nitrogen and the bromine vapor flows from the Br₂ bubbler 64 to an unheated KBr bubbler 68. Bromine is absorbed from the gas stream into the potassium bromide (KBr) solution in the KBr bubbler 68. Any bromine not absorbed into the KBr solution is removed in the Br₂ trap 70 which contains a potassium iodide (KI) solution. In the Br₂ trap 70, the bromine oxidizes the iodide ion to elemental iodide and is converted to bromide ion. A subsequent determination of the iodine content in the Br₂ trap 70 allows a calculation of the amount of bromine which is not absorbed in the KBr solution. A thermocouple 72 is inserted into the KBr solution in the KBr bubbler 68 to read the temperature of the KBr solution.

In a second desorption experimental step, nitrogen from N₂ tank 62 or methane from methane tank 74 is introduced into the electrically heated KBr bubbler 68 at a rate of 15 mL/min as is determined by the rotometer 66 and verified with a bubble meter and a stopwatch. The nitrogen/methane functions as a stripping/carrier gas to convey elemental bromine removed from the KBr solution by heating. A sample port 76 is installed between the KBr bubbler 68 and the Br₂ trap 70 to sample the bromine mole percent present in the gas. The mixture of bromine vapor and stripping gas is then routed into the Br₂ trap 70 (containing fresh KI solution). A Variac temperature controller is used to control the temperature of the KBr bubbler 68 during desorption. The rate of bromine desorption is measured as a function of temperature over a range of 40° C. to 94° C.

Two test runs each comprising an absorption step followed by a desorption step are performed in accordance with the preceding procedures.

### Run 1:

An aqueous KBr solution was prepared and added to KBr bubbler 68.

An aqueous KI solution was also prepared and added to Br2 trap 70. This KI solution efficiently traps any bromine which is not absorbed in KBr bubbler 68, because bromine readily oxidizes iodide to iodine causing the bromine to be reduced to bromide. The amount of bromine trapped can then be quantitatively determined by titration of the iodine which is formed.

Run 1 Absorption Step:

The weight loss in the Br₂ bubbler 64 over the course of the absorption was 59.07 g of bromine.

The weight gain in the KBr bubbler 68 was 43.45 g due to the uptake of bromine into the solution. Weight percentage of bromine was <0.04 wt % at start-up and 9.76 wt % at completion. Weight percentage of bromide was 25.9 wt % at start-up and 23.4 wt % at completion of the experiment. The weight gain of the Br₂ trap 70 was 1.26 g. Weight percentage of elemental bromine was 0 wt % at start-up and 0.41 wt % at completion of absorption. Weight percentage of bromide at start-up was 0 wt % and 0.36 wt % at completion of the absorption.

Approximately 3.50 g of bromine was left in the lines that were not weighed at the end of the experiment.

Approximately 1.39 g of bromine was lost due to sampling.

Run 1 Desorption Step:

The desorption step was conducted with a nitrogen purge at a 15 mL/min flow rate and at a temperature range of from 40° C. to 94° C. to determine under which conditions the optimum rate of desorption would be reached.

A total of 53 gas samples were taken during the desorption step resulting in the following findings: Desorption at a constant temperature of 40° C. occurred for a total of 275 minutes which yielded 1.10 g of bromine, equivalent to a desorption rate of 0.24 g/hr. The temperature was then raised to 60° C. and held constant for 315 minutes which yielded an additional 2.72 g of bromine, equivalent to a rate of 0.52 g/hr. The temperature was then further raised to 80° C. and held constant for 2,185 minutes which yielded an additional 14.91 g of bromine, equivalent to a rate of 0.41 g/hr. The KBr bubbler 68 was then heated to 94° C. and held constant for 75 minutes which yielded an additional 1.12 g of bromine at a rate of 0.90 g/hr; however, at the higher temperature of 94° C., substantial vaporization of water from the bubbler 68 over to the Br₂ trap 70 occurred. The total run time for the desorption step was 2,850 minutes and yielded a total of 19.85 g of bromine (as predetermined by gas sampling).

Of the initial solution weight gain of 43.45 g due to the absorption of bromine, 32.01 g of bromine was subsequently purged out of the potassium bromide solution in the desorption step, with 24.24 g of the 32.01 g being captured by the Br₂ trap 70, and 3.44 g being captured by the water trap 78 installed after the Br₂ trap 70. The total weight accounted for was 30.75 g, leaving 1.26 g unaccounted for or still remaining in the tubing. Of the 43.45 g of bromine dissolved into the KBr solution from the absorption step, 11.44 g remained in the KBr bubbler 68 after the desorption step.

Run 2:

KBr bubbler 68 was drained and refilled with fresh KBr solution.

Br2 trap 70 was drained and refilled with fresh KI solution. This KI solution efficiently traps any bromine which was not absorbed in KBr bubbler 68, because bromine readily oxidizes iodide to iodine causing the bromine to be reduced to bromide. The amount of bromine trapped can then be quantitatively determined by titration of the iodine which is formed.

Run 2 Absorption Step:

For Run 2, the KBr solution was initially spiked with 39.4 g of bromine prior to the start of the absorption step in order to reduce the time needed to approach saturation during the experiment. The weight loss in the Br₂ bubbler 64 over the course of the absorption was 97.48 g of bromine.

The weight gain in the KBr bubbler 68 due to the absorption of bromine was 79.26 g. Weight percentage of bromine was <0.04 wt % before spiking the solution with the 39.41 g of bromine. After the initial bromine spiking and the completion of the absorption step, the final bromine concentration in the solution was 24.3 wt %. Weight percentage of bromide was 25.6 wt % at start-up and 20.1 wt % at completion of absorption. The weight gain of the bromine trap 70 was 9.45 g. Weight percentage of bromine was 0 wt % at initial and 3.2 wt % at completion of absorption. Weight percentage of bromide at start-up was 0 wt % and 3.4 wt % at completion of the absorption.

During the run, the nitrogen/bromide feed stream was found to contain 13.5 wt % bromine, and the nitrogen effluent stream exiting the potassium bromide bubbler 68 was found to contain 4.5 wt % bromine at the completion of the absorption step.

Run 2 Desorption Step:

The desorption step was conducted with methane at a flow rate of 15 mL/min and at a temperature of 60° C. to determine the amount of bromine released.

A total of 29 gas samples were taken during the desorption step resulting in the following findings: Desorption was run at 60° C. for a total of 1,665 minutes which yielded 23.8 g of bromine (as per gas sampling) equivalent to a desorption rate of 0.86 g/hr.

Of the initial absorption solution weight gain of 118.67 g (including the initial 39.41 g bromine spike), 40.17 g of bromine was purged out of the KBr bubbler 68, 35.45 g of bromine was captured by the Br2 trap 70, 0.81 g was lost to sampling, 1.43 g was captured in the water trap 76, and approximately 2.46 g of bromine was left in tubing and stop cocks used for sampling. Thus, substantially all (99.9%) of the bromine purged from the KBr bubbler 68 could be accounted for within the calculations. Of the 118.67 g of bromine dissolved in the KBr solution in bubbler 68 after the absorption step, 78.5 g still remained in solution after the desorption step at 60° C.

Certain embodiments of the methods of the invention are described herein. Although major aspects of what is to believed to be the primary chemical reactions involved in the methods are discussed in detail as it is believed that they occur, it should be understood that side reactions may take place. One should not assume that the failure to discuss any particular side reaction herein means that that reaction does not occur. Conversely, those that are discussed should not be considered exhaustive or limiting. Additionally, although figures are provided that schematically show certain aspects of the methods of the present invention, these figures should not be viewed as limiting on any particular method of the invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. All numbers and ranges disclosed above may vary by some amount. Whenever a numerical range with a lower limit and an upper limit is disclosed, any number and any included range falling within the range are specifically disclosed.

What is claimed is:

1. A process comprising:
contacting a gas stream comprising bromine with a liquid bromide stream comprising bromide anions to produce at least an off-gas stream that is substantially bromine free and a liquid stream comprising bromine anionic complexes; and
heating at least a portion of the liquid stream to produce at least bromine from at least a portion of the bromine anionic complexes.

2. The process of claim 1, wherein the gas stream is at a temperature below about 50° C.

3. The process of claim 1, wherein the gas stream comprises bromine in an amount of about 5 wt % or less.

4. The process of claim 1, wherein the gas stream comprises nitrogen in an amount of about 77 wt % to about 98 wt %, oxygen in an amount of about 1 wt % to about 20 wt %, and bromine in an amount of about 1 wt % to about 2 wt %.

5. The process of claim 1, further comprise cooling the liquid bromide stream to a temperature of about 50° C. or less.

6. The process of claim 1, wherein the bromide anions are from a bromide-anion source selected from the group consisting of an alkali-metal bromide, an alkaline-earth metal bromide, and combinations thereof.

7. The process of claim 1, wherein the liquid bromide stream comprises hydrogen bromide dissolved in water.

8. The process of claim 1, wherein the off-gas stream comprises bromine in an amount of about 10 parts per million by weight or less.

9. The process of claim 1, wherein the off-gas stream comprises bromine in an amount of about 1 parts per million by weight or less.

10. The process of claim 1, further comprising contacting the gas stream with a water stream to remove bromide in the gas stream that was vaporized from the liquid bromide stream.

11. The process of claim 1, wherein the heating further comprises contacting the liquid stream with a stripping gas.

12. The process of claim 1, wherein the heating comprises feeding at least a portion of the liquid stream into a stripper column, wherein a bottoms liquids stream from the stripper column is heated to form a gas stream that countercurrently contacts the liquid stream in the stripper column.

13. The process of claim 12, further comprising partially condensing an overhead gas stream from the stripper column to form bromine gas stream and a liquid stream, the bromine gas stream being at a temperature of about 60° C. to about 90° C.

14. The process of claim 1, further comprising converting gaseous alkanes to liquid hydrocarbons, the converting producing at least a portion of the gas stream used to contact the liquid bromide stream.

15. The process of claim 1, further comprises oxidizing hydrogen bromide to form at least a portion of the gas stream.

16. A process comprising:
contacting a gas stream comprising bromine with a liquid bromide stream comprising hydrogen bromide dissolved in water in an absorption stage to remove bromine from the gas stream and produce at least a liquid stream comprising bromine anionic complexes, wherein the bromine is removed such that the gas stream comprises bromine in an amount about 10 parts per million by weight or less;
contacting the gas stream with a water stream in the absorption stage to remove bromides from the gas stream such that the gas stream comprises hydrogen bromide in an amount of about 10 parts per million by weight or less, wherein the bromides in the gas stream were vaporized from the liquid bromide stream; and
heating at least a portion of the liquid stream to convert at least a portion of the bromine anionic complexes to bromine and hydrogen bromide.

17. The process of claim 16, wherein the heating further comprises contacting the liquid stream with a stripping gas in a stripper column, wherein a bottoms liquids stream from the stripper column is heated to form a gas stream that countercurrently contacts the liquid stream in the stripper column.

18. The process of claim 17, further comprising partially condensing an overhead gas stream from the stripper column to form bromine gas stream and a liquid stream, the bromine gas stream being at a temperature of about 60° C. to about 90° C.

19. The process of claim 16, further comprising: reacting alkyl bromides over a catalyst to produce higher molecular weight hydrocarbons and hydrogen bromide; and oxidizing at least a portion of the hydrogen bromide to form at least a portion of the gas stream.

20. A system comprising:
an absorber column having an inlet for a liquid bromide stream and an inlet for a gas stream comprising bromine, the absorber column being configured to countercurrently contact the liquid bromide stream with the gas stream so as to dissolve at least a portion of the bromine in the liquid bromine stream and produce at least an off-gas stream that is substantially bromine free and a liquid stream comprising bromine anionic complexes; and
a stripper column having an inlet for the liquid stream, the stripper column being configured to heat the liquid stream releasing bromine from the liquid stream.
